(19) United States
(12) Patent Application Publication
(10) Pub. No.: US 2015/0192153 A1
(43) Pub. Date: Jul. 9, 2015

(54) Hydraulic Fluid Drying Device

(71) Applicant: Mary Reed, Myrtle Beach, SC (US)

(72) Inventor: Mary Reed, Myrtle Beach, SC (US)

(73) Assignee: Dry Hydraulics LLC, Morrisville, NC (US)

(21) Appl. No.: 14/566,812

(22) Filed: Dec. 11, 2014

Related U.S. Application Data
(60) Provisional application No. 61/924,046, filed on Jan. 6, 2014.

(51) Int. Cl. F15B 21/04; B01D 15/10

(52) U.S. Cl. CPC F15B 21/041; B01D 15/10

(57) ABSTRACT

An apparatus and a method of use of such removes water from a mixture of water and hydraulic fluid. The hydraulic fluid drying device includes a containment vessel, a desiccant mixture and a tether. The containment vessel is a permeable fabric which allows water to traverse the boundary but not hydraulic fluid. The desiccant mixture is secured within the containment vessel, adsorbing the water from a mixture of hydraulic fluid and water within a storage tank. Once placed into the tank, the containment vessel is removed when the desiccant mixture is saturated or when a predetermined period of time has elapsed.

The current application claims a priority to the U.S. Provisional Patent application Ser. No. 61/924,046 filed on Jan. 6, 2014.

### FIELD OF THE INVENTION

The present invention relates generally to an apparatus and method for removing water from hydraulic fluid in a reservoir tank. More specifically, the present invention removes emulsified water from a hydraulic fluid reserve through osmosis and adsorption.

### BACKGROUND OF THE INVENTION

The presence of a water contaminate in hydraulic fluid can cause damage to down-stream components, not providing the proper lubrication or even corroding various metal components. Since water and hydraulic fluid are immiscible, a mixture of water and hydraulic fluid may either be homogeneous or heterogeneous. In a homogeneous mixture, the water is emulsified throughout the hydraulic fluid, whereas in a heterogeneous mixture the hydraulic fluid and the water are present in separate layers. Typically, a well mixed mixture would not separate into a heterogeneous mixture without the water content being higher than the saturation quantity, 200-300 parts per million (ppm). Water becomes present in a hydraulic storage tank through condensation of air, improper separations from previous processes, through faulty equipment, or other miscellaneous means. As previously mentioned, when the water content exceeds a predetermined corrosive limit, the life of downstream components can be shortened through surface corrosion, metal fatigue, and can cause fouling through colonization of microbes. Metal fatigue occurs when moving metal parts are not properly lubricated increasing the friction between moving parts. The presence of excessive water prevents the moving parts from being properly lubricated. Modern solutions to this issue include desiccant breathers which attempt to prevent humid air from entering the fluid system. This method, however, requires constant maintenance where the desiccant filters become saturated and need to be replaced. If the desiccant filters are not replaced upon saturation, the humid air simply passes through the filter contaminating the hydraulic fluid system.

Therefore, an object of the present invention is to remove water from the hydraulic fluid such that the water content is low enough to prevent damage to downstream components. Through the use of a desiccant mixture, water is removed from a mixture of water and hydraulic fluid within a storage tank. The desiccant mixture is stored within a permeable containment vessel. The containment vessel is deposited within the storage tank where the water content within is adsorbed into the desiccant. The containment vessel is then removed and the adsorbed water along with the containment vessel.

The present invention has been tested using different materials and compositions. Select examples are presented to exemplify the effectiveness of these different materials and compositions.

### EXAMPLE 1

5 grams of zeolite with a 3 angstrom pore size and 5 grams of activated alumina were mixed together. The mixture was placed into a woven nylon fabric container that is shaped into a tube. The ends of the tube were crimped closed. A tether was attached through one of the crimped ends. The container was placed into 1 liter of hydraulic oil that contained 1000 ppm of water; the oil appeared cloudy. After twelve hours, the oil became clear, showing that the entrained water had been removed.

### EXAMPLE 2

Cross-linked polyacrylamide was placed into a polypropylene container that is shaped into a tube. The ends of the tube were heat crimped closed. The container was placed into 1 liter of hydraulic oil that contained 1000 ppm of water; the oil appeared cloudy. After twelve hours, the oil remained cloudy, showing that the entrained water had not been removed.

### EXAMPLE 3

Hydroxyethyl Cellulose, Carbomethyl Cellulose was placed into a polypropylene container that is shaped into a tube. The ends of the tube were heat crimped closed. The container was placed into 1 liter of hydraulic oil that contained 1000 ppm of water; the oil appeared cloudy. After twelve hours, the oil remained cloudy, showing that the entrained water had not been removed.

### EXAMPLE 4

10 grams Silica gel was placed into a polypropylene container that is shaped into a tube. The ends of the tube were heat crimped closed. The container was placed into 1 liter of hydraulic oil that contained 1000 ppm of water; the oil appeared cloudy. In twelve hours, the oil remained cloudy, showing that the entrained water had not been removed.

### EXAMPLE 5

10 grams Activated Carbon was placed into a polypropylene container that is shaped into a tube. The ends of the tube were heat crimped closed. The container was placed into 1 liter of hydraulic oil that contained 1000 ppm of water; the oil appeared cloudy. In twelve hours, the oil remained cloudy, showing that the entrained water had not been removed.

### EXAMPLE 6

10 grams Montmorillonite clay was placed into a polypropylene container that is shaped into a tube. The ends of the tube were heat crimped closed. The container was placed into 1 liter of hydraulic oil that contained 1000 ppm of water; the oil appeared cloudy. In twelve hours, the oil remained cloudy, showing that the entrained water had not been removed.

### EXAMPLE 7

The fabric used for the container were: napped polypro, cotton, flannel, polypropylene micro felt, twill, melt blown polypropylene, polyester felt, or spun bonded polyester. The containers were tested in hydraulic oil that had enough water added to it to phase separate. After twelve hours the container fabric would not allow water to permeate any of the devices, so none of them removed the phase separated water.

### BRIEF DESCRIPTION OF THE DRAWINGS

FIG. 1 is a perspective view of the present invention.

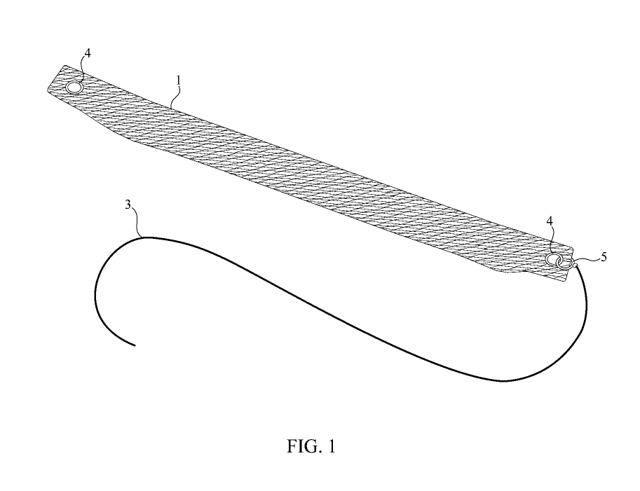

FIG. 2 is a diagram of the present invention during its preferred use.

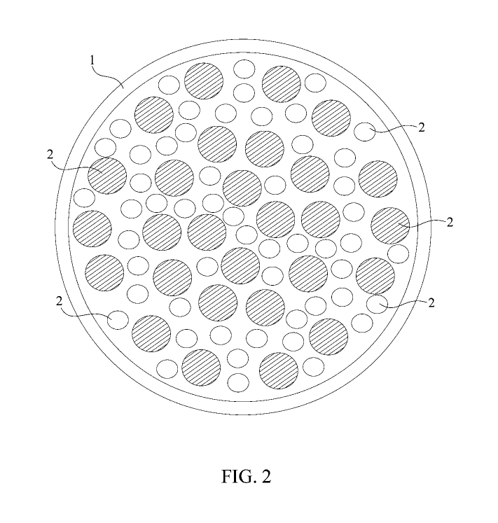

FIG. 3 is a cross-sectional view of the containment vessel of the present invention.

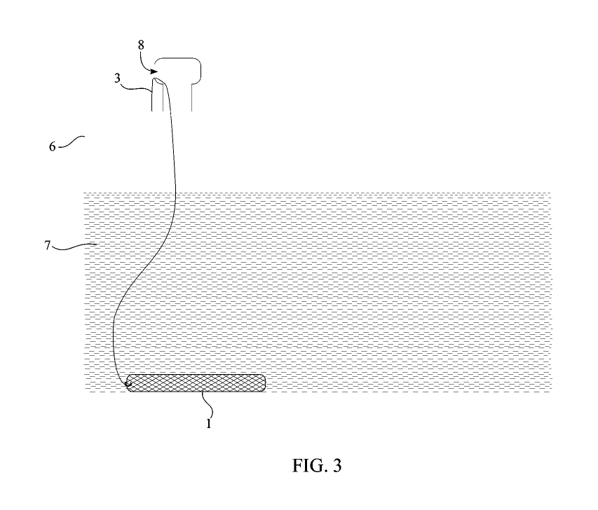

FIG. 4 is a flow diagram for the method of use of the present invention.

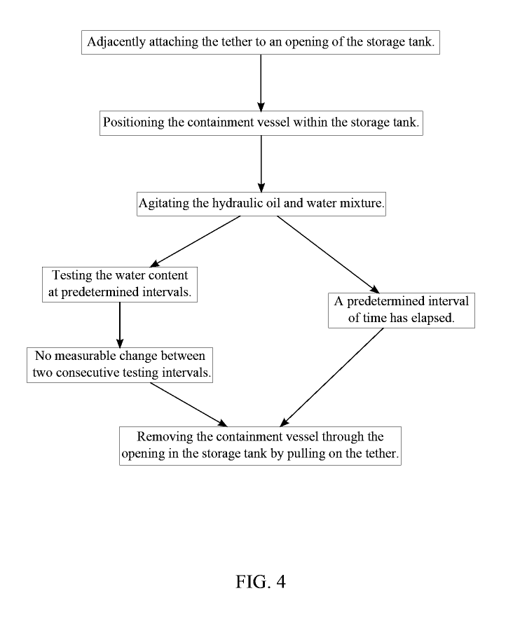

### DETAIL DESCRIPTIONS OF THE INVENTION

All illustrations of the drawings are for the purpose of describing selected versions of the present invention and are not intended to limit the scope of the present invention.

The present invention is a hydraulic fluid drying device. The present invention removes water from a storage tank of hydraulic fluid in order to protect downstream machinery and other components. The presence of water prevents the proper lubrication of moving parts causing metal fatigue, corrosion, and fouling. Metal fatigue reduces the life of metal components through frictional heat due to moving parts. The hydraulic fluid limits the amount of friction and dissipates the heat effectively. The presence of water within the hydraulic fluid, however, reduces the effectiveness of the heat dissipation and lubrication in comparison to pure hydraulic fluid. Additionally, the presence of water can cause corrosion by assisting with oxidation of metal components. Fouling can occur when microbes form colonies form within the water content of the hydraulic fluid and water mixture which inhibit fluid flow and movement of mechanical parts. The present invention seeks to reduce and eliminate issues caused by the presence of water within hydraulic fluid.

The present invention comprises a containment vessel 1, a desiccant mixture 2, and a tether 3. By crimping the ends of the containment vessel 1, the desiccant mixture 2 is enclosed within the containment vessel 1. The containment vessel 1 is permeable or porous such that water can easily enter the containment vessel 1 to be absorbed by the desiccant mixture 2. The tether 3 allows the user to attach the containment vessel 1 to a storage tank 6 such that the containment vessel 1 is easily retrievable for replacement.

As previously mentioned, the desiccant mixture 2 is confined within the containment vessel 1. In the preferred embodiment, the desiccant mixture 2 is a homogeneous mixture, which is evenly distributed throughout the containment vessel 1. Evenly distributing the desiccant mixture 2 allows for the even absorption of water throughout the containment vessel 1. The particle size of the desiccant mixture 2 is equal such that the mixture does not settle into layers. Alternatively, the desiccant mixture 2 may be layer or separated as a heterogeneous mixture within the containment vessel 1.

The desiccant mixture 2 is inert with the hydraulic fluid, wherein the desiccant mixture 2 does not dissolve or degrade in the presence of hydraulic fluid. The desiccant mixture 2 is selected from the group consisting of, but not limited to, aluminosilicate minerals, porous glasses, zeolites, active alumina, molecular sieves and combinations thereof. These substances have a high water adsorbance capacity while being non-reactive with hydraulic fluid. The active alumina further provides the ability to neutralize acids within the hydraulic fluid and decompose peroxides preventing the formation of radicals which react adversely to rubber components of the hydraulic system, such as seals and gaskets. The desiccant has a preferred pore size of 3-4 angstroms.

The containment vessel 1 is preferably made from a fabric material which filters and permeates water through the boundary while retaining the desiccant mixture 2. The fabric material is resistant to strong acids, weak acids, strong alkalis, weak alkalis, organic chemicals, and salt solutions. The fabric material includes, but is not limited to, polypropylene, napped polypro, cotton, flannel, nylon, twill, and polyester. These materials further resist wear from heavy use. Further in accordance with the preferred embodiment, the containment vessel 1 should be dimensionally stable across a large temperature range, approximately −30° F. to 400° F. The preferred fabric weighs between 2-5 ounces per square yard and has a mesh density of 0.01, 0.1, or 0.5 microns.

Further in accordance to the preferred embodiment, the present invention comprises a grommet 4 and a linking ring 5. The grommet 4 provides support for a tether 3 to be attached to the containment vessel 1 to prevent tearing and wear of the fabric of the containment vessel 1 during use of the present invention. The linking ring 5 connects the tether 3 to the containment vessel 1. The linking ring 5 is adjacently connected to the tether 3 and coupled with the grommet 4. The linking ring 5 allows for the tether 3 to be removeably attached to the containment vessel 1, such that the tether 3 may be reused.

The preferred method of use for the present invention to remove water from a storage tank 6 containing a hydraulic fluid and water mixture 7 comprises the steps of: positioning the containment vessel 1 within the storage tank 6; adsorbing water from within the hydraulic fluid and water mixture 7; and separating the water from the hydraulic fluid and water mixture 7 by removing the containment vessel from the storage tank 6.

When positioning the containment vessel 1 into the storage tank 6, the tether 3 is adjacently attached to an opening of the storage tank 8. The containment vessel 1 is tethered to the storage tank 6, such that once the desiccant mixture 2 becomes saturated, the containment vessel 1 is removed easily.

For instance, when water is emulsified in the hydraulic fluid, the containment vessel 1 is positioned within the storage tank 6, such that the containment vessel 1 interfaces with the hydraulic fluid and water mixture 7. Water then permeates through the containment vessel 1 and is adsorbed by the desiccant mixture 2. The hydraulic fluid and water mixture 7 is agitated to accelerate the rate of which the water is adsorbed into the containment vessel 1.

Alternatively, when the hydraulic fluid and water are separated into layers within the storage tank 6, the containment vessel 1 is positioned such that it interfaces with the water layer. By increasing or decreasing the weight of the containment vessel 1, the height at which the containment vessel is placed in the hydraulic fluid and water mixture 7.

In order to determine whether or not the desiccant mixture 2 has been saturated, the water content of the hydraulic fluid and water mixture 7 is assessed at predetermined intervals. If no change is detected for the water content between two consecutive testing intervals, the containment vessel 1 is removed from the storage tank 6. Alternatively, the containment vessel 1 is removed from the storage tank 6 after a predetermined interval of time. Once the desiccant mixture 2 has been saturated or the predetermined interval of time is reached, the containment vessel 1 is removed through an opening of the storage tank 6 by pulling on the tether 3.

Although the invention has been explained in relation to its preferred embodiment, it is to be understood that many other possible modifications and variations can be made without departing from the spirit and scope of the invention as hereinafter claimed.

What is claimed is:

1. A hydraulic fluid drying device comprises:
a containment vessel;
a desiccant mixture;
a tether;
the tether being adjacently connected to the containment vessel;
the desiccant mixture being enclosed within the containment vessel; and
the containment vessel being made of a water permeable material.

2. The hydraulic fluid drying device, as claimed in claim 1, comprises:
the desiccant mixture being inert with hydraulic fluid, wherein the desiccant mixture does not dissolve or degrade in the presence of hydraulic fluid.

3. The hydraulic fluid drying device, as claimed in claim 1, comprises:
the desiccant mixture being selected from a group consisting of aluminosilicate minerals, porous glasses, zeolites, active alumina, molecular sieves and combinations thereof.

4. The hydraulic fluid drying device, as claimed in claim 1, comprises:
a pore size of the desiccant mixture;
the pore size of the desiccant mixture being between three and four angstroms;

5. The hydraulic fluid drying device, as claimed in claim 1, comprises:
the desiccant mixture being a homogenous mixture within the containment vessel.

6. The hydraulic fluid drying device, as claimed in claim 1, comprises:
the desiccant mixture being a heterogeneous mixture within the containment vessel.

7. The hydraulic fluid drying device, as claimed in claim 1, comprises:
the containment vessel being resistant to strong acids, weak acids, strong alkalis, weak alkalis, organic chemicals, and salt solutions.

8. The hydraulic fluid drying device, as claimed in claim 1, comprises:
a grommet;
a linking ring;
the grommet being embedded into the containment vessel;
the linking ring being adjacently connected to the tether; and
the linking ring being coupled with the grommet.

9. A method of using the hydraulic fluid drying device as claimed in claim 1 comprises the steps of:
providing a storage tank, wherein the storage tank contains a hydraulic fluid and water mixture;
positioning the containment vessel within the storage tank;
absorbing the water within the hydraulic fluid and water mixture into the containment vessel with the desiccant mixture; and
separating the water from the hydraulic fluid and water mixture by removing the containment vessel from the storage tank.

10. The method of using a hydraulic fluid drying device, as claimed in claim 7, comprises the steps of:
adjacently attaching the tether to an opening of the storage tank.

11. The method of using a hydraulic fluid drying device, as claimed in claim 7, comprises the steps of:
wherein the water is emulsified in the hydraulic fluid;
wherein the containment vessel is positioned within the storage tank; and
agitating the hydraulic fluid and water mixture in order to accelerate the water being absorbed into the containment vessel.

12. The method of using a hydraulic fluid drying device, as claimed in claim 7, comprises the steps of:
wherein the containment vessel is positioned within the storage tank;
assessing a water content value for the mixture at predetermined testing intervals; and
removing the containment vessel from the storage tank,
if no change is detected in the water content value between two consecutive testing intervals.

13. The method of using a hydraulic fluid drying device, as claimed in claim 7, comprises the steps of:
removing the containment vessel after a predetermined duration.

14. The method of using a hydraulic fluid drying device, as claimed in claim 7, comprises the steps of:
removing the containment vessel through an opening in the storage tank by pulling on the tether.
